(19) United States
(12) Patent Application Publication
(10) Pub. No.: US 2020/0177759 A1
(43) Pub. Date: Jun. 4, 2020

(54) IMAGE READING DEVICE AND IMAGE FORMING APPARATUS

(71) Applicant: Konica Minolta, Inc., Tokyo (JP)

(72) Inventor: Tianzi Xu, Tokyo (JP)

(73) Assignee: Konica Minolta, Inc., Tokyo (JP)

(21) Appl. No.: 16/698,048

(22) Filed: Nov. 27, 2019

(30) Foreign Application Priority Data
Nov. 29, 2018 (JP) 2018-222974

(51) Int. Cl. H04N 1/047; H04N 1/00

(52) U.S. Cl. CPC H04N 1/047; H04N 1/00702; H04N 1/0057; H04N 1/00793; H04N 1/00673; H04N 1/00737

(57) ABSTRACT

An image reading device includes: an image reader that reads an image formed on a medium; an adjusting member that adjusts a distance between the image reader and the medium in a reading position facing the image reader; and a hardware processor that controls the adjusting member to perform switching between a first arrangement and a second arrangement, wherein in the first arrangement, the image reader reads an image formed on a first surface of the medium, the first surface is on an image reader side, and in the second arrangement, the image reader reads an image formed on a second surface of the medium.

### CROSS-REFERENCE TO RELATED APPLICATION

The entire disclosure of Japanese Patent Application No. 2018-222974, filed on Nov. 29, 2018, is incorporated herein by reference.

### BACKGROUND

### Technical Field

The present invention relates to an image reading device and an image forming apparatus including the image reading device.

### Description of the Related Art

As high-mix low-volume print jobs are becoming more popular compared to conventional high-volume print jobs, it is becoming more necessary to process print orders with shorter lead time. In the small to medium-sized label market, high-mix low-volume production using a digital production printer is in demand, and it is required to provide printed products with stable quality. In view of the above, there has been proposed an image reading device that reads the color, position, scale, and so on of an image printed on sheet by a digital printer (image forming apparatus), and feeds back correction amounts based on the read information to the digital printer. The image reading device includes, for example, a scanner having an illumination device (light source) that emits light to sheet and a line sensor that reads information on the light reflected from the sheet. The image reading device can read line information in a sheet width direction, and can read information in a sheet conveyance direction through conveyance by a sheet conveyer, in a reading position. The scanner allows reading an image in a wide range at a faster speed and a lower cost than a colorimeter.

Before outputting images to be printed, the user places the image forming apparatus in an adjustment mode to correct the images in accordance with information read by the scanner. In the adjustment mode, color information of the first image read by the scanner can be fed back as a correct value to the second and subsequent images. Accordingly, when the user prints the images, automatic image correction can be performed with high productivity by reading the images with the scanner.

There is disclosed, as an example of the scanner described above, a device that can accurately read the color of an image formed on sheet, by specifying a reading range of the image, based on a color determination region determined based on the reading position of a sensor and the arrangement position of a pressing member that minimizes fluttering of sheet (see, for example, Japanese Patent Application Publication No. 2018-117200 (JP 2018-117200 A)).

There is also disclosed a device that can read information on a document accurately and quickly regardless of the sheet thickness of the document, by setting a clearance through which a document medium to be read passes to a predetermined distance or less (see, for example, Japanese Patent Application Publication No. 10-290318 (JP 10-290318)).

To stably read the color of an image using a scanner, the vertical position (reading height) in the reading position (focus position) needs to be accurately set. If sheet flutters in the vertical direction in the reading position, a large color difference occurs due to a change in amount of reflected light in an exposer. In the configuration disclosed in JP 2018-117200 A, while a reference member is fixed with respect to a background member facing a reader, a pressing member is biased against the sheet surface. Therefore, in the case of the configuration disclosed in JP 2018-117200 A, the distance between the reading surface of the sheet and the reader (reading height) varies with the sheet thickness, resulting in a reduced reading accuracy.

Whereas, in the configuration disclosed in JP 10-290318 A, a guide plate biased by a biasing member lifts sheet to the reader, so that information on the sheet surface is read regardless of the sheet thickness. Accordingly, information on the sheet surface can be read with the distance between the reading surface and the reader fixed. However, in the configuration disclosed in JP 10-290318 A, the distance between the reading surface and the reader cannot be adjusted. Therefore, if the surface to be read is changed according to a job (for example, if the surface to be read is changed from the front surface to the back surface), the reading accuracy is reduced. Moreover, since the bottom surface of the reader, sheet, and the guide plate are in tight contact, the bottom surface of the reader, sheet, and the guide plate may be damaged, and dust may adhere thereto. That is, in the case of the configuration disclosed in JP 10-290318 A, the reading accuracy and the image quality are reduced.

### SUMMARY

One or more embodiments of the present invention provide an image reading device that ensures sufficient reading accuracy and image quality, regardless of the thickness of sheet, and an image forming apparatus including the image reading device.

An image reading device according to one or more embodiments of the present invention, including:

an image reader that reads an image formed on a medium;

an adjusting member that adjusts a distance between the image reader and the medium in a reading position facing the image reader; and

a hardware processor that performs switching between a first arrangement in which the image reader reads an image on a first surface of the medium, the first surface being on an image reader side, and a second arrangement in which the image reader reads an image on a second surface of the medium different from the first surface, by controlling the adjusting member.

An image forming apparatus according to one or more embodiments of the present invention including:

an image former that forms an image on a medium; and

the above-described image reading device that reads the image formed on the medium by the image former.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are no intended as a definition of the limits of the present invention, wherein:

FIG. 1 illustrates a schematic configuration of an image forming apparatus according to one or more embodiments;

FIG. 2 is a block diagram illustrating a main functional configuration of the image forming apparatus according to one or more embodiments;

FIG. 3 illustrates a first arrangement of an image reading device according to one or more embodiments;

FIG. 4 illustrates a second arrangement of the image reading device according to one or more embodiments;

FIG. 5 illustrates a modification of a configuration for moving pressing members according to one or more embodiments;

FIG. 6 is a flowchart illustrating an example of operations of the image reading device according to one or more embodiments;

FIG. 7 illustrates a first arrangement of an image reading device according to one or more embodiments;

FIG. 8 illustrates a second arrangement of the image reading device according to one or more embodiments;

FIG. 9 illustrates a first arrangement of an image reading device according to one or more embodiments

FIG. 10 illustrates a second arrangement of the image reading device according to one or more embodiments.

### DETAILED DESCRIPTION

Hereinafter, embodiments of the present invention will be described with reference to the drawings. However, the scope of the invention is not limited to the disclosed embodiments.

### 1. Description of Configuration

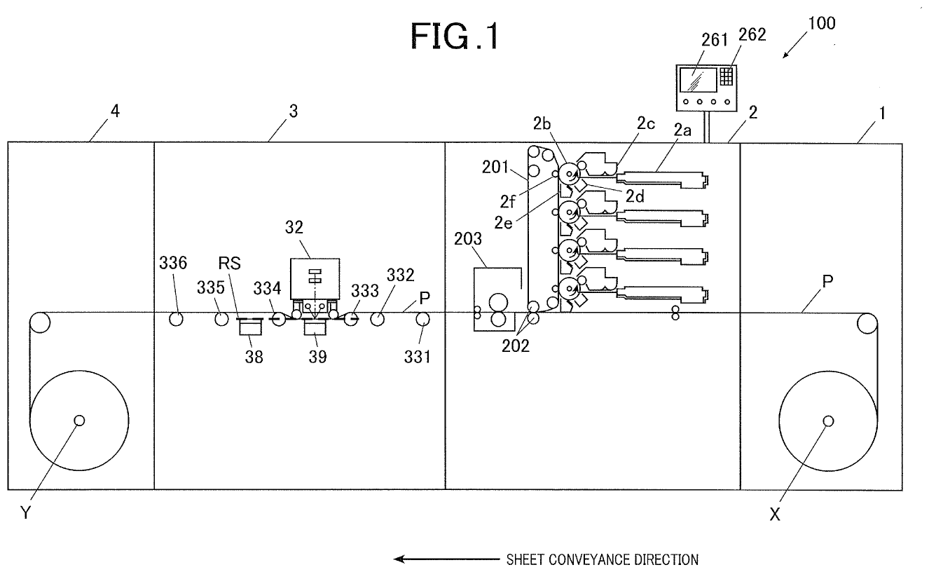

An image forming apparatus 100 according to one or more embodiments of the present invention is an apparatus that forms an image on rolled continuous sheet (medium: continuous medium) P. As illustrated in FIG. 1, the image forming apparatus 100 includes a sheet feeding device 1, a main body unit 2, an image reading device 3, and a winding device 4, which are connected in this order from the upstream side in a conveyance direction of the continuous sheet P (sheet conveyance direction). Although the image forming apparatus 100 illustrated in one or more embodiments of the present invention is configured to convey the continuous sheet P corresponding to a medium, the present invention is not limited thereto. The image forming apparatus 100 may be configured to convey cut sheet.

The sheet feeding device 1 is a device that feeds the continuous sheet P to the main body unit 2. The sheet feeding device 1 conveys the continuous sheet P, which is wound around a support shaft X, to the main body unit 2 at a constant speed, via a plurality of conveyance roller pairs such as unwinding rollers and feeding rollers. The feeding operation of the sheet feeding device 1 is controlled by a controller 21 of the main body unit 2.

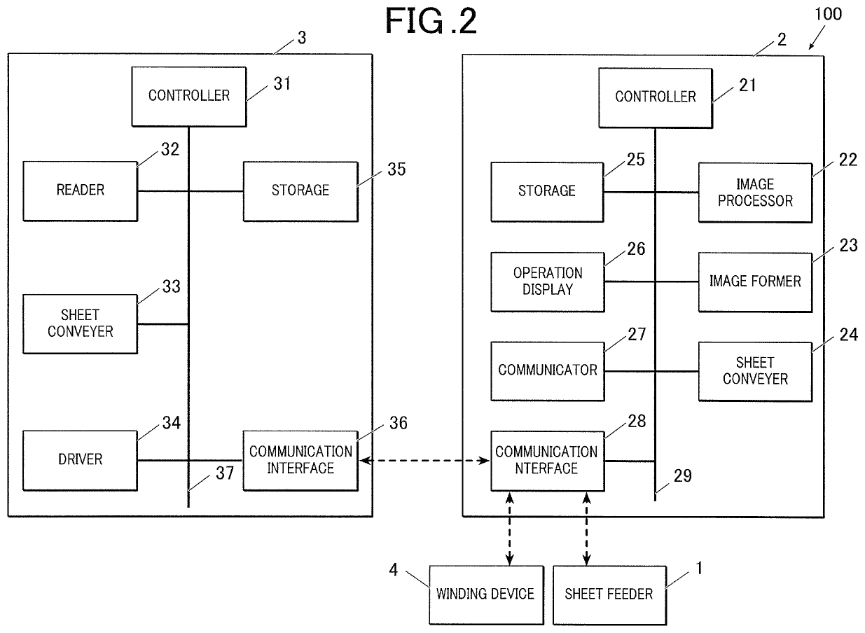

The main body unit 2 performs image formation based on an intermediate transfer system using an electrophotographic process technique. As illustrated in FIG. 2, the main body unit 2 includes the controller 21, an image processor 22, an image former 23, a sheet conveyer 24, a storage 25, an operation display 26, a communicator 27, and a communication interface 28, which are connected to each other via a bus 29.

The controller 21 includes a CPU, a ROM, a RAM, and so on. The CPU of the controller 21 reads a program corresponding to the processing content from the ROM, loads the program to the RAM, and executes the loaded program to centrally control the operations of the blocks of the main body unit 2, the sheet feeding device 1, the image reading device 3, the winding device 4, and so on.

The image processor 22 performs image processing, such as density correction processing, rasterization processing, color conversion processing, and halftone processing, on image data of a job input via the communicator 27 and so on, and outputs the resulting image to the image former 23.

As illustrated in FIG. 1, the image former 23 includes: four sets of an exposer 2a, a photoreceptor 2b, a developer 2c, a charger 2d, a cleaner 2e, and a primary transfer roller 2f, corresponding to respective color components of Y (yellow), M (magenta), C (cyan), and B (black); an intermediate transfer body 201; secondary transfer rollers 202; and a fixer 203. Based on input image data, the image former 23 forms toner images of different colors on the photoreceptors 2b of the corresponding colors, and sequentially primarily transfers the toner images onto the intermediate transfer body 201 to superpose the toner images of four colors. After that, the image former 23 secondarily transfers the toner images onto the continuous sheet P fed from the sheet feeding device 1, using the secondary transfer rollers 202, thereby forming an image on the continuous sheet P. Then, the formed image is fixed on the continuous sheet P by the fixer 203.

The sheet conveyer 24, which includes a plurality of roller and a drive source thereof, conveys the continuous sheet P conveyed from the sheet feeding device 1.

The storage 25 includes, for example, a non-volatile semiconductor memory (so-called flash memory), a hard disk drive, or the like. The storage 25 stores image data of a received job, setting information of the job, and the like. These pieces of data may be stored in the RAM of the controller 21.

The operation display 26, which includes, for example, a liquid crystal display (LCD) with a touch panel, serves as a display 261 and an operation interface 262.

The display 261 displays various operation screens, the image conditions, the operation status of various functions, and the like, according to a display control signal received from the controller 21.

The operation interface 262, which includes various operation keys such as numeric keys and a start key, receives various input operations, and outputs an operation signal to the controller 21.

The communicator 27, which includes a communication control card such as a local area network (LAN) card, exchanges various types of data with external devices (for example, personal computers) connected to a communication network such as a LAN and a wide area network (WAN).

The communication interface 28 includes a communication interface for connecting to the sheet feeding device 1, the image reading device 3, and the winding device 4.

The image reading device 3 reads the continuous sheet P with an image formed thereon by the main body unit 2 so as to obtain a read image. As illustrated in FIG. 2, the image reading device 3 includes a controller (hardware processor) 31, a reader (image reader) 32, a sheet conveyer (conveyer) 33, a driver 34, a storage 35, and a communication interface 36, which are connected each other via a bus 37. As illustrated in FIG. 1, the image reading device 3 further includes a calibration member 38, and a background member 39.

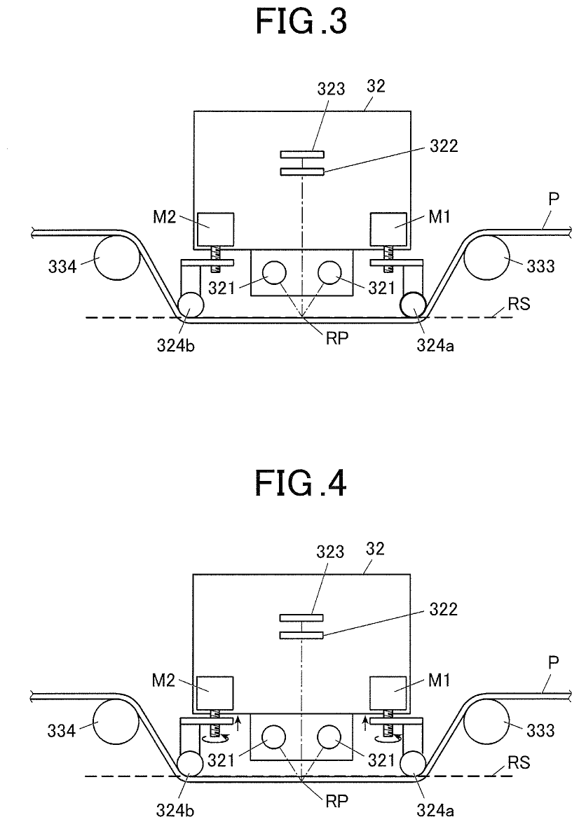

The controller 31 includes a CPU, a ROM, a RAM, and so on. The CPU of the controller 31 reads a program corresponding to the processing content from the ROM, loads the program to the RAM, and executes the loaded program to centrally control the operations of the blocks of the image reading device 3, according to a control signal transmitted from the main body unit 2. In one or more embodiments of the present invention, the controller 31 executes a switching control operation (see FIG. 6) to control switching of the arrangement of elements (pressing members 324a and 324b) in the image reading device 3 between a first arrangement (see FIG. 3) and a second arrangement (see FIG. 4). Specifically, the controller 31 performs switching between the first arrangement for the reader 32 to read a reader-32-side first surface of the continuous sheet P and the second arrangement for the reader 32 to read a second surface of the continuous sheet P different from the first surface, by controlling (adjusting) the positions of the pressing members 324a and 324b.

The reader 32, which includes a light source 321, a lens 322, and a CCD line sensor 323, optically scans the continuous sheet P conveyed from the main body unit 2 to a reading position RP, focuses the light reflected from the continuous sheet P onto a light receiving surface of the CCD line sensor 323 to form an image thereon by using the lens 322, and photoelectrically converts the image to generate a read image.

As illustrated in FIGS. 3 and 4, the pressing member 324a and the pressing member 324b corresponding to an adjusting member (first pressing members) according to one or more embodiments of the present invention that adjusts the distance between the reader 32 and the continuous sheet P in the reading position RP facing the reader 32 are arranged upstream and downstream of the reader 32 in the sheet conveyance direction.

The pressing members 324a and 324b are disposed on the reader 32 side of the conveyance path of the continuous sheet P conveyed by the sheet conveyer 33. The pressing members 324a and 324b are arranged parallel to a reading surface RS (surface in the reading position RP on which the lens 322 is focused (surface that the reader 32 can most clearly read)) of the reader 32. The pressing members 324a and 324b are movable in the direction perpendicular to the reading surface RS by the motors M1 and M2. Specifically, the arrangement in the image reading device 3 can be switched between the first arrangement (see FIG. 3) and the second arrangement (see FIG. 4), by moving the pressing members 324a and 324b in the direction perpendicular to the reading surface RS using the motors M1 and M2. Note that the initial arrangement is the first arrangement.

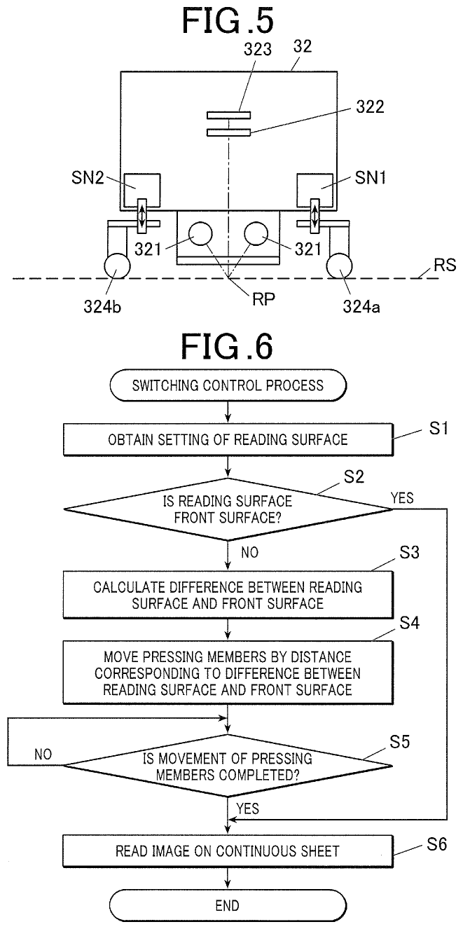

In the examples depicted in FIGS. 3 and 4, the motors M1 and M2 are illustrated as the structures for moving the pressing members 324a and 324b in the direction perpendicular to the reading surface RS. However, the present invention is not limited thereto. For example, as illustrated in FIG. 5, solenoids SN1 and SN2 may be used in place of the motors M1 and M2.

When in the first arrangement illustrated in FIG. 3, the pressing members 324a and 324b locate a reader-32-side sheet surface (front surface: first surface) of the continuous sheet P passing through the reading position RP, on the reading surface RS to be read by the reader 32, in response to application of tension to the continuous sheet P by the conveyance members 333 and 334. That is, when in the first arrangement, the tangent lines of the pressing members 324a and 324b coincide with the reading surface RS.

Whereas, when in the second arrangement illustrated in FIG. 4, the pressing members 324a and 324b locate a sheet surface (back surface: second surface) different from the reader-32-side sheet surface of the continuous sheet P passing the reading position RP, on the reading surface RS to be read by the reader 32, in response to application of tension to the continuous sheet P by the conveyance members 333 and 334.

The pressing members 324a and 324b may be, for example, rollers or rod-shaped members extending in the direction (main scanning direction) orthogonal to the sheet conveyance direction. However, considering that the continuous sheet P and the pressing members 324a and 324b may become damaged, members such as rollers that can be rotated by the continuous sheet P may be used in one or more embodiments. The material of the pressing members 324a and 324b is not especially limited, and materials such as metal and rubber may be used, for example.

As illustrated in FIG. 1, the sheet conveyer 33 includes, for example, a plurality of conveyance members 331 to 336 to convey the continuous sheet P conveyed from the main body unit 2, along a sheet conveyance path. The conveyance members 331 to 336 are arranged in this order from the upstream side to the downstream side in the sheet conveyance direction.

As illustrated in FIG. 4, the conveyance member 333, which is adjacent to the pressing member 324a disposed upstream in the sheet conveyance direction, is located such that the position where the conveyance member 333 is in contact with the continuous sheet P is located farther (higher) from the reading surface RS than the position where the pressing member 324a is in contact with the continuous sheet P. Similarly, the conveyance member 334, which is adjacent to the pressing member 324b disposed downstream, is located such that the position where the conveyance member 334 is in contact with the continuous sheet P is located farther (higher) from the reading surface RS than the position where the pressing member 324b is in contact with the continuous sheet P. With this configuration, since the conveyance members 333 and 334 can be located farther (higher) from the reading surface RS than the position where the pressing members 324a and 324b are in contact with the continuous sheet P, it is possible to locate the sheet surface (front surface) on the reading surface RS regardless of the sheet thickness by applying tension to the continuous sheet P in the reading position RP. This allows reading with high accuracy.

That is, the conveyance members 333 and 334 serve as a tension applicator that applies tension to the continuous sheet P.

The driver 34 includes a drive source (such as a motor) for rotating the conveyance members 331 to 336, and a gear coupled to an output shaft of the drive source.

The storage 35, which includes a non-volatile memory, stores an image read by the reader 32, calibration values of the reader 32, and so on.

The communication interface 36 includes a communication interface for connecting to the sheet feeding device 1, the image reading device 3, and the winding device 4.

The calibration member 38 is a plate-shaped member with a white surface used for calibrating the reader 32.

The background member 39 is a plate-shaped member with a black surface used as a reflector when reading the continuous sheet P.

The calibration member 38 and the background member 39 are configured such that either one of them is located to face the reader 32 in accordance with the intended use.

The winding device 4 is a device that winds the continuous sheet P conveyed from the image reading device 3, around a support shaft Y at a constant speed, via a plurality of conveyance roller pairs (for example, unwinding rollers and feeding rollers). The winding operation of the winding device 4 is controlled by the controller 21 of the main body unit 2.

### 2. Description of Operations

An operation (switching control process) of the image reading device 3 in the image forming apparatus 100 according to one or more embodiments of the present invention will be described with reference to the flowchart of FIG. 6. This process starts upon receiving a start signal of a print operation (conveyance of the continuous sheet P) from the main body unit 2.

First, the controller 31 of the image reading device 3 obtains the setting of a reading surface of the continuous sheet P (step S1). The setting of the reading surface of the continuous sheet P is a setting indicating which of the front surface and the back surface is the sheet surface to be read by the reader 32. Note that the sheet surface to be read is not limited to the front surface and the back surface, and may be, for example, a plane located between the front surface and the back surface.

Then, the controller 31 refers to the setting of the reading surface of the continuous sheet P obtained in step S1 to determine whether the sheet surface to be read is the front surface (step S2).

If the sheet surface to be read is the front surface (step S2: YES), the process proceeds to step S6.

On the other hand, if the sheet surface to be read is not the front surface (for example, the sheet surface to be read is the back surface) (step S2: NO), the process proceeds to the next step S3.

In step S3, the controller 31 calculates the difference between the reading surface (in this example, the back surface) of the continuous sheet P and the front surface of the continuous sheet P.

Then, the controller 31 controls the motors M1 and M2 to move the pressing members 324a and 324b in the direction perpendicular to the reading surface RS by a distance corresponding to the difference between the reading surface and the front surface of the continuous sheet P calculated in step S3 (step S4). In this manner, the arrangement of the image reading device 3 is switched from the first arrangement to the second arrangement.

Then, the controller 31 determines whether the movement of the pressing members 324a and 324b in step S4 is completed (step S5).

If the movement of the pressing members 324a and 324b in step S4 is completed (step S5: YES), the process proceeds to the next step S6.

On the other hand, if the movement of the pressing members 324a and 324b in step S4 is not completed (step S5: NO), the controller 31 repeats step S5 until the movement of the pressing members 324a and 324b is completed.

In step S6, the controller 31 reads an image on the continuous sheet P using the reader 32. Then, the controller 31 transmits the read image to the main body unit 2 via the communication interface 36.

Then, the main body unit 2 calculates correction values of the color, position, scale, and so on of the image, based on the read image transmitted from the image reading device 3, and feeds back the correction values to image formation.

### 3. Advantageous Effects

As described above, the image reading device 3 of the image forming apparatus 100 according to one or more embodiments of the present invention includes: an image reader (reader 32) that reads an image formed on a medium (continuous sheet P); an adjusting member that adjusts a distance between the image reader and the medium in the reading position RP facing the image reader; and the controller 31 that performs switching between the first arrangement in which the image reader reads an image on a first surface of the medium, the first surface being on an image reader side, and the second arrangement in which the image reader reads an image on a second surface of the medium different from the first surface, by controlling the adjusting member.

Therefore, the image reading device 3 according to one or more embodiments of the present invention can adjust the relative positions of the image reader and the adjusting member, so that the distance between the surface of the medium to be read and the image reader can be adjusted to a reading height of the image reader. Accordingly, it is possible to accurately read images on media of different materials in different print systems. For example, even when an image is formed on the back surface or in the middle of a transparent material, the image can be read accurately through the material. Therefore, it is possible to secure sufficient reading accuracy and image quality regardless of the sheet thickness.

Further, the image reading device 3 according to one or more embodiments of the present invention includes: a conveyer (sheet conveyer 33) that conveys a continuous medium (continuous sheet P) to the reading position RP; and a tension applicator (conveyance members 333 and 334) that applies tension to the continuous medium. Further, the adjusting member includes first pressing members (pressing members 324a and 324b) that are disposed on an image reader side of a conveyance path of the continuous medium conveyed by the conveyer, that are arranged upstream and downstream of the image reader in a medium conveyance direction so as to be parallel to the reading surface RS of the image reader, and that locate the first surface of the continuous medium passing through the reading position RP, on the reading surface RS to be read by the image reader, in response to application of tension to the continuous medium by the tension applicator, when in the first arrangement.

Therefore, the image reading device 3 according to one or more embodiments of the present invention can adjust the distance between the surface of the medium to be read and the image reader to a reading height of the image reader regardless of the sheet thickness, by pressing the first pressing members against the continuous medium. Accordingly, it is possible to secure reading accuracy.

Further, in the image reading device 3 according to one or more embodiments of the present invention, the first pressing members are movable in the direction perpendicular to the reading surface RS, and the controller 31 performs switching between the first arrangement and the second arrangement by adjusting the positions of the first pressing members.

Accordingly, in the image reading device 3 according to one or more embodiments of the present invention, the distance between the surface of the medium to be read and the image reader can be easily controlled by moving the first pressing members in the direction perpendicular to the reading surface RS. Therefore, the reading accuracy can be easily secured.

Although the present invention has been described in conjunction with one or more embodiments, the present invention is not limited to the above embodiments, and changes and modifications may be made without departing from the scope of the present invention.

Modifications

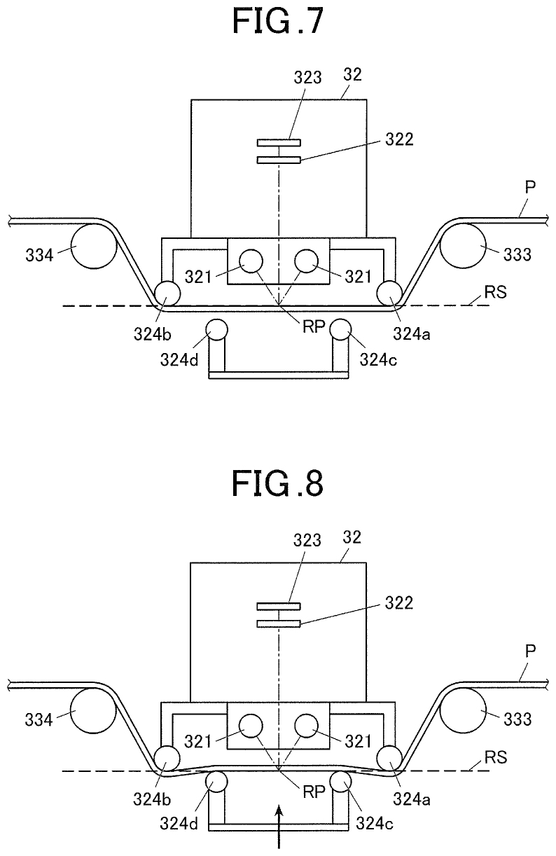

For example, the example illustrated in FIGS. 7 and 8 is different from the configuration of the aforementioned embodiments in that the pressing members 324a and 324b are fixed (that is, the motors M1 and M2 are not provided, and therefore the pressing members 324a and 324b do not move in the direction perpendicular to the reading surface RS), and that pressing members (adjusting member) 324c and 324d capable of lifting the continuous sheet P from the lower side in the direction perpendicular to the reading surface RS are provided. For simplicity of explanation, elements identical to those of the aforementioned embodiments are denoted by the same reference numerals, and will not be described in detail herein.

In Modification 1 of one or more embodiments, the pressing members 324a and 324b are fixed such that their tangent lines coincide with the reading surface RS.

The pressing members 324c and 324d corresponding to second pressing members according to one or more embodiments of the present invention are arranged upstream and downstream of the reader 32 in the sheet conveyance direction, on the inner side of the pressing members 324a and 324b corresponding to the first pressing members according to one or more embodiments of the present invention. Further, the pressing members 324c and 324d are arranged to face the reader 32, with the conveyance path of the continuous sheet P conveyed by the sheet conveyer 33 interposed therebetween. Furthermore, the pressing members 324c and 324d are arranged parallel to the reading surface RS of the reader 32. Moreover, the pressing members 324c and 324d are movable in the direction perpendicular to the reading surface RS by motors, solenoids, or the like (not illustrated). Specifically, the arrangement in the image reading device 3 can be switched between the first arrangement (see FIG. 7) and the second arrangement (see FIG. 8), by moving the pressing members 324c and 324d in the direction perpendicular to the reading surface RS using the motors, solenoids, or the like (not illustrated). Note that the initial arrangement is the first arrangement.

That is, the controller 31 performs switching from the first arrangement to the second arrangement, by moving the pressing members 324c and 324d toward the reader 32.

When in the first arrangement illustrated in FIG. 7, the pressing members 324c and 324d are arranged in positions not in contact with the continuous sheet P. Accordingly, in response to application of tension to the continuous sheet P by the conveyance members 333 and 334 while the positions of the pressing members 324a and 324b with their tangent lines coinciding with the reading surface RS, the reader-32-side sheet surface (front surface) of the continuous sheet P passing the reading position RP is disposed on the reading surface RS to be read by the reader 32.

Further, when in the second arrangement illustrated in FIG. 8, the pressing members 324c and 324d are arranged in positions to lift the continuous sheet P to a position higher than in the first arrangement in the direction perpendicular to the reading surface RS. Specifically, when in the second arrangement, the pressing members 324c and 324d are arranged such that the sheet surface (back surface) different from the reader-32-side sheet surface of the continuous sheet P is located on the reading surface RS to be read by the reader 32. Accordingly, when in the second arrangement, the pressing members 324c and 324d locate the sheet surface (back surface) different from the reader-32-side sheet surface of the continuous sheet P passing through the reading position RP, on the reading surface RS to be read by the reader 32.

The pressing members 324c and 324d may be, for example, rollers or rod-shaped members extending in the direction (main scanning direction) orthogonal to the sheet conveyance direction. However, considering that the continuous sheet P and the pressing members 324c and 324d may become damaged, members such as rollers that can be rotated by the continuous sheet P may be used in one or more embodiments. The material of the pressing members 324c and 324d is not especially limited, and materials such as metal and rubber may be used, for example.

As described above, the image reading device 3 according to Modification 1 of one or more embodiments includes: the conveyer (sheet conveyer 33) that conveys the continuous medium (continuous sheet P) to the reading position RP; the tension applicator (conveyance members 333 and 334) that applies tension to the continuous medium; and the first pressing members (pressing members 324a and 324b) that are disposed on an image reader side of a conveyance path of the continuous medium conveyed by the conveyer, that are arranged upstream and downstream of the image reader in the medium conveyance direction so as to be fixed parallel to the reading surface RS of the image reader, and that locate the first surface of the continuous medium passing through the reading position RP, on the reading surface RS to be read by the image reader, in response to application of tension to the continuous medium by the tension applicator, when in the first arrangement. The adjusting member includes second pressing members (pressing members 324c and 324d) that are arranged to face the image reader with the conveyance path of the continuous medium conveyed by the conveyer interposed therebetween, that are arranged upstream and downstream of the image reader in a medium conveyance direction, on the inner side of the first pressing members, so as to be parallel to the reading surface RS of the image reader, and that are movable in a direction perpendicular to the reading surface RS. The controller 31 performs switching from the first arrangement to the second arrangement, by moving the second pressing members toward the image reader.

Accordingly, in the image reading device 3 of Modification 1 of one or more embodiments, since the first pressing members on the image reader side are fixed, it is possible to secure the position accuracy of the first pressing members and to reduce vibration to be received by the image reader. Therefore, reading stability and accuracy can be secured in the first arrangement defined by the first pressing members. Further, the distance between the surface of the medium to be read and the image reader can be adjusted to a reading height of the image reader, by moving the second pressing members in the direction perpendicular to the reading surface RS. Therefore, the reading accuracy can be secured.

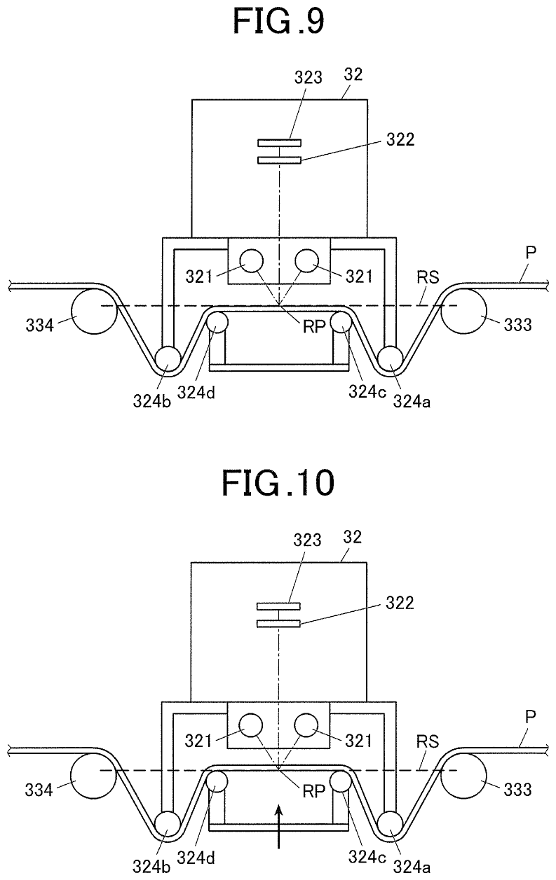

The example illustrated in FIGS. 9 and 10 is different from the configuration of the aforementioned embodiments of the present invention in that the pressing members 324a and 324b are fixed (that is, the motors M1 and M2 are not provided, and therefore the pressing members 324a and 324b do not move in the direction perpendicular to the reading surface RS); that pressing members 324c and 324d capable of lifting the continuous sheet P from the lower side in the direction perpendicular to the reading surface RS are provided; and that the positioning for the first arrangement is performed by the pressing members 324c and 324d. For simplicity of explanation, elements identical to those of the aforementioned embodiments are denoted by the same reference numerals, and will not be described in detail herein.

In Modification 2 of one or more embodiments, the pressing members 324a and 324b are fixed below the reading surface RS in the direction perpendicular to the reading surface RS.

The pressing members 324c and 324d corresponding to second pressing members according to one or more embodiments of the present invention are arranged upstream and downstream of the reader 32 in the sheet conveyance direction, on the inner side of the pressing members 324a and 324b corresponding to the first pressing members according to one or more embodiments of the present invention. The pressing members 324c and 324d are arranged to face the reader 32, with the conveyance path of the continuous sheet P conveyed by the sheet conveyer 33 interposed therebetween. Furthermore, the pressing members 324c and 324d are arranged parallel to the reading surface RS of the reader 32. Moreover, the pressing members 324c and 324d are disposed on the reader 32 side of the pressing members 324a and 324b in the direction perpendicular to the reading surface RS. Moreover, the pressing members 324c and 324d are movable in the direction perpendicular to the reading surface RS by motors, solenoids, or the like (not illustrated). Specifically, the arrangement in the image reading device 3 can be switched between the first arrangement (see FIG. 9) and the second arrangement (see FIG. 10), by moving the pressing members 324c and 324d in the direction perpendicular to the reading surface RS using the motors, solenoids, or the like (not illustrated). Note that the initial arrangement is the first arrangement.

That is, the controller 31 performs switching from the first arrangement to the second arrangement, by moving the pressing members 324c and 324d toward the reader 32.

When in the first arrangement illustrated in FIG. 9, the pressing members 324c and 324d locate the reader-32-side sheet surface (front surface) of the continuous sheet P passing through the reading position RP, on the reading surface RS to be read by the reader 32, in response to application of tension to the continuous sheet P by the conveyance members 333 and 334. That is, specifically, when in the first arrangement, the pressing members 324c and 324d are arranged such that the reader-32-side sheet surface (front surface) of the continuous sheet P is located on the reading surface RS to be read by the reader 32.

Further, when in the second arrangement illustrated in FIG. 10, the pressing members 324c and 324d are arranged in positions to lift the continuous sheet P to a position higher than in the first arrangement in the direction perpendicular to the reading surface RS. Specifically, when in the second arrangement, the pressing members 324c and 324d are arranged such that the sheet surface (back surface) different from the reader-32-side sheet surface of the continuous sheet P is located on the reading surface RS to be read by the reader 32. Accordingly, when in the second arrangement, the pressing members 324c and 324d locate the sheet surface (back surface) different from reader-32-side sheet surface of the continuous sheet P passing through the reading position RP, on the reading surface RS to be read by the reader 32, in response to application of tension to the continuous sheet P by the conveyance members 333 and 334. That is, when in the second arrangement, the tangent lines of the pressing members 324c and 324d coincide with the reading surface RS.

The pressing members 324c and 324d may be, for example, rollers or rod-shaped members extending in the direction (main scanning direction) orthogonal to the sheet conveyance direction. However, considering that the continuous sheet P and the pressing members 324c and 324d may become damaged, members such as rollers that can be rotated by the continuous sheet P may be used in one or more embodiments. The material of the pressing members 324c and 324d is not especially limited, and materials such as metal and rubber may be used, for example.

As described above, the image reading device 3 according to Modification 2 of one or more embodiments includes: the conveyer (sheet conveyer 33) that conveys the continuous medium (continuous sheet P) to the reading position RP; the tension applicator (conveyance members 333 and 334) that applies tension to the continuous medium; and the first pressing members (pressing members 324a and 324b) that are disposed on an image reader side of a conveyance path of the continuous medium conveyed by the conveyer, and that are arranged upstream and downstream of the image reader in the medium conveyance direction so as to be fixed parallel to the reading surface RS of the image reader. Further, the adjusting member includes second pressing members (pressing members 324c and 324d) that are arranged to face the image reader with the conveyance path of the continuous medium conveyed by the conveyer interposed therebetween, that are arranged upstream and downstream of the image reader in a medium conveyance direction, on the inner side of the first pressing members, so as to be parallel to the reading surface RS of the image reader, that are disposed on the image reader side of the first pressing members in the direction perpendicular to the reading surface RS, that are movable in the direction perpendicular to the reading surface, and that locate the first surface of the continuous medium passing through the reading position RP, on the reading surface RS to be read by the image reader, in response to application of tension to the continuous medium by the tension applicator, when in the first arrangement. The controller 31 performs switching from the first arrangement to the second arrangement, by moving the second pressing members toward the image reader.

Accordingly, in the image reading device 3 of Modification 2 of one or more embodiments, the first arrangement is defined not by the first pressing members that are fixed, but by the second pressing members that are movable in the direction perpendicular to the reading surface RS. Therefore, even if the surface of the medium facing the image reader is embossed or irregular, the distance between the surface of the medium to be read and the image reader can be adjusted to the reading height of the image reader. Accordingly, it is possible to secure reading accuracy. Further, since the reading position can be adjusted also in the direction away from the image reader with respect to the first arrangement, by moving the second pressing members in the direction away from the image reader, the adjustment range of the reading position can be increased.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. An image reading device comprising:
an image reader that reads an image formed on a medium;
an adjusting member that adjusts a distance between the image reader and the medium in a reading position facing the image reader; and
a hardware processor that controls the adjusting member to perform switching between a first arrangement and a second arrangement of the image reader, wherein
in the first arrangement, the image reader reads an image formed on a first surface of the medium,
the first surface is on an image reader side, and
in the second arrangement, the image reader reads an image formed on a second surface of the medium.

2. The image reading device according to claim 1, further comprising:
a conveyer that conveys a continuous medium to the reading position along a conveyance path; and
a tension applicator that applies a tension to the continuous medium, wherein
the adjusting member comprises first pressing members that are disposed on an image reader side of the conveyance path and along a medium conveyance direction so as to be parallel to a reading surface of the image reader, and
in the first arrangement, the first pressing members locate, on the reading surface, a first surface of the continuous medium passing through the reading position while the tension applicator applies the tension to the continuous medium.

3. The image reading device according to claim 2, wherein
the first pressing members are movable in a direction perpendicular to the reading surface, and
the hardware processor performs the switching by adjusting positions of the first pressing members.

4. The image reading device according to claim 1, further comprising:
a conveyer that conveys a continuous medium to the reading position along a conveyance path; and
a tension applicator that applies a tension to the continuous medium, wherein
the adjusting member comprises first pressing members that are disposed on an image reader side of the conveyance path and along a medium conveyance direction so as to be parallel to a reading surface of the image reader, and
in the first arrangement, the first pressing members locate, on the reading surface, a first surface of the continuous medium passing through the reading position while the tension applicator applies the tension to the continuous medium,
the adjusting member further comprises second pressing members that are arranged to face the image reader,
the conveyance path of the medium conveyed by the conveyer is interposed between the second pressing members and the image reader,
the second pressing members are disposed on an inner side of the first pressing members and along a medium conveyance direction so as to be parallel to the reading surface,
the second pressing members are movable in the direction perpendicular to the reading surface, and
the hardware processor moves the second pressing members toward the image reader and performs switching from the first arrangement to the second arrangement.

5. The image reading device according to claim 1, further comprising:
a conveyer that conveys a continuous medium to the reading position along a conveyance path;
a tension applicator that applies a tension to the continuous medium; and
first pressing members that are disposed on an image reader side of the conveyance path and along a medium conveyance direction so as to be parallel to a reading surface of the image reader, wherein
the adjusting member comprises second pressing members that are arranged to face the image reader,
the conveyance path conveyed by the conveyer is interposed between the second pressing members and the image reader,
the second pressing members are disposed on an inner side of the first pressing members and along a medium conveyance direction so as to be parallel to the reading surface of the image reader,
the second pressing members are disposed on an image reader side of the first pressing members in the direction perpendicular to the reading surface,
the second pressing members are movable in the direction perpendicular to the reading surface,
in the first arrangement, the second pressing members locate, on the reading surface, a first surface of the continuous medium passing through the reading position while the tension applicator applies the tension to the continuous medium, and
the hardware processor moves the second pressing members toward the image reader and performs switching from the first arrangement to the second arrangement.

6. An image forming apparatus comprising:
an image former that forms an image on a medium; and
the image reading device of claim 1 that reads the formed image by the image former.
